(19) United States
(12) Patent Application Publication
(10) Pub. No.: US 2009/0027896 A1
(43) Pub. Date: Jan. 29, 2009

(54) IMAGE FORMING DEVICE

(75) Inventors: Kazuo Nishimura, Fukuoka (JP); Yuzo Kawano, Fukuoka (JP); Kohei Suyama, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/914,009

(22) PCT Filed: Apr. 20, 2006
(86) PCT No.: PCT/JP2006/308305

§ 371 Date: Nov. 9, 2007

(30) Foreign Application Priority Data
May 10, 2005 (JP) 2005-137033

(51) Int. Cl. F21V 5/04; F21V 15/00

(52) U.S. Cl. 362/311.06; 362/362

(57) ABSTRACT

A downsized and flattened exposure device is provided. A substrate (301) is supported only at either one side in the width direction (403) of the substrate surface that is orthogonal to the direction of the row and supported by only one enclosing member (201) at least in the section in the direction of the row of light emitting elements (401) where the light emitting elements (401) are arranged. With this structure, even if the substrate is supported at multiple points, the substrate is subject to almost no distortion due to multipoint support, allowing the substrate to have a reduced size in the width direction, further downsizing and flattening the exposure device.

### TECHNICAL FIELD

The present invention relates to an exposure device and an image forming apparatus and particularly to an optical recording head using line light emitting elements as a light source and an image forming apparatus using the same.

### BACKGROUND ART

Recently, image forming apparatuses for forming color images have come to be extensively used in practical use. Particularly, color image forming apparatuses having multiple image carriers have been developed along with conventional color image forming apparatuses in which multiple rotations (for example four rotations) result in one copy with the help of image forming productivity.

FIG. 11 shows an exemplary structure of a conventional color image forming apparatus having multiple photosensitive bodies as the image carrier.

In FIG. 11, four photosensitive bodies 1101 to 1104 and a transfer unit 1105 extended over them are shown. Charging devices 1106 to 1109, exposure devices 1110 to 1113, developing devices 1114 to 1117, and photosensitive body cleaning devices 1118 to 1121 are provided around the photosensitive bodies 1101 to 1104, respectively.

Developing agent storages 1122 to 1125 store the corresponding color toners to the developing devices 1114 to 1117, respectively. The stored toners are supplied to the developing devices 1114 to 1117, respectively, in a manner in which the image recorded on paper has a nearly uniform density.

The transfer unit 1105 comprises a belt transfer element 1126, a drive roller 1127 for rotating and transferring the belt transfer element 1126, a press roller 1129 for pressing the belt transfer element 1126 via a recording paper 1128, a support roller 1130 positioned on the opposite side to the drive roller 1127, and a tension roller 1131 for tensing the belt transfer element 1126 during the image forming so as to flatten the surface of the belt transfer element that abuts or faces the photosensitive bodies 1101 to 1104. In FIG. 11, the belt transfer element 1126 is a so-called intermediate transfer element on the surface of which a toner image directly placed before it is transferred to a recording paper. Instead, for example, the belt transfer element 1126 can be a transfer paper conveyer on which paper is placed by suction and a toner image is placed on the paper.

The transfer unit 1105 is provided with a belt cleaning device 1132 for removing so-called residual toner that was not transferred to the recording paper 1128 and remains on the surface of the belt transfer element 1126.

The color image forming apparatus shown in FIG. 11 further comprises a paper feed cassette 1133 for storing the recording paper 1128, a feed roller 1135 for feeding the recording paper 1128 from the paper feed cassette 1133 to a recording paper transfer part 1134 consisting of the support roller 1130 and press roller 1129, a paper feed part 1138 consisting of a pickup roller 1136, a resist roller 1137, and others, and a fixing device 1139 for fixing the toner image transferred to the surface of the recording paper 1128.

Exposure devices 1110 to 1113 are described hereafter.

A known prior art exposure device in the image forming apparatus in which a latent image is written on the photosensitive body has a line head type LED array. (Patent Citation 1) and (Patent citation 2) describe an exposure device in which a U-shaped enclosing member is processed to have an optical path recovery opening (slit) at the bottom and a lens is fitted in the slit.

FIG. 12 is a cross-sectional view of a prior art line head type LED array exposure device 1110 in the sub-scanning direction. The exposure devices 1111, 1112, and 1113 also have the same structure as the exposure device 1110.

In FIG. 12, an LED light emitting element array substrate 1203, which faces the back of a gradient index rod lens array 1202 provided in an enclosing member 1201, and an opaque cover 1204 shielding the LED light emitting element array substrate 1203 from the back of the enclosing member 1201 are provided in the exposure device 1110.

An LED light emission part 1205 is wire-connected to a drive circuit on the LED light emitting element array substrate 1203 by wire bonding 1206. The LED light emission part 1205 is small-pitched; therefore, the wire bonding 1206 is alternately extended to either side of the LED light emission part 1205, which must then be positioned nearly on the center line of the LED light emitting element array substrate 1203.

The enclosing member 1201 is contoured for example by die-casting. Then, an optical path opening 1207 for withdrawing the light from the light emitting element is formed at the bottom of the enclosing member 1201 in the secondary processing. For ensuring accuracy of mounting, the positions at which the LED light emitting element array substrate 1203 and gradient index rod lens array 1202 which abut the enclosing member 1201 are formed during the secondary processing, which is costly.

The LED light emitting element array substrate 1203 and gradient index rod lens array 1202 each abut the enclosing member so that their positional relationship is regulated for a specific focal length. Here, the LED light emitting element array substrate 1203 abuts the enclosing member on the side where the LED light emitting element and drive circuit are provided.

A fixed plate spring 1208 presses a cover 1204 against the back of the enclosing member 1201 to seal the enclosing member 1201 in a light tight manner. In other words, the LED light emitting element array substrate 1203 is optically sealed in the enclosing member 1201 by the fixed plate spring 1208. The fixed plate spring 1208 is provided at multiple points in the longitudinal direction of the enclosing member 1201.

The above described exposure device is desirably further downsized and flattened for further downsizing the image forming apparatuses and improving the degree of freedom of system design.

[Patent Citation 1] Japanese Laid-Open Patent Application Publication No. S63-104858

[Patent Citation 2] Japanese Laid-Open Patent Application Publication No. 2002-96495

### SUMMARY OF THE INVENTION

In the above described line head type LED array exposure device having the prior art structure, the wire connecting the LED light emitting elements and the drive circuit is extended on either side of the light emitting elements. The LED light emitting element array is positioned nearly in the center of the LED light emission substrate, and nearly on the center line of the substrate. The optical path opening of the enclosing member is positioned nearly on the center line of the bottom surface, making it difficult to reduce the dimension in the sub-scanning direction, so it is difficult to downsize and flatten the exposure device.

According to (Patent Citation 1) and (Patent Citation 2), the slit is positioned nearly on the center line of the bottom surface of the U-shaped enclosing member in the sub-scanning direction. The thickness of the head unit in the sub-scanning direction is equal to the thickness of the bottom surface of the U-shaped enclosing member in the sub-scanning direction, making it difficult to reduce the thickness of the bottom surface in the sub-scanning direction because the strength during the slit formation has to be ensured, so it is difficult to flatten the head.

As shown in FIG. 12, the LED light emitting element array substrate 1203 and gradient index rod lens array 1202 each abut the enclosing member so that their positional relationship is regulated to a specific focal length. The LED light emitting element array substrate 1203 abuts the enclosing member on the side where the LED light emitting element and drive circuit are provided. Therefore, the LED light emitting element array substrate needs an abutting area to abut the enclosing member in addition to the LED light emitting element area and drive circuit area, which is disadvantageous for downsizing the LED light emitting element substrate.

The light emitting element array substrate carries not only light emitting elements but also a drive circuit for driving the light emitting elements and increases the size for that, which is a bottleneck to the exposure device being flattened.

The present invention is invented to resolve the above problems and the purpose of the present invention is to propose an exposure device further downsized and flattened.

In order to achieve the above purpose, the present invention provides an exposure device in which light emitting elements provided to individual pixels constituting an image are used as a light source to emit light according to image information and illuminate an external photosensitive body with the light, comprising an enclosure having one or a plurality of enclosing members and a substrate placed inside the enclosure and having a row of a plurality of light emitting elements, wherein the substrate is supported only at either one side in the width direction of the substrate surface that is orthogonal to the direction of the row and supported by only one of the enclosing members at least in the section in the direction of the row where the light emitting elements are arranged.

In the present invention, the substrate is supported only at either one side in the width direction of the substrate surface that is orthogonal to the direction of the row and supported by only one of the enclosing members at least in the section in the direction of the row of the plurality of light emitting elements where the light emitting elements are arranged. Therefore, the substrate is supported by a stable one enclosing member. Even if the substrate is supported at multiple points, the substrate is subject to almost no distortion due to multipoint-support. In addition, the substrate is supported at an area on only one side in the width direction. The substrate is allowed to have a reduced size in the width direction, further flattening the exposure device.

### BRIEF DESCRIPTION OF THE DRAWINGS

FIG. 1 is a schematic illustration showing the structure of a color image forming apparatus according to an embodiment of the present invention.

FIG. 2 is a perspective view of the exposure device according to an embodiment of the present invention.

FIG. 3 is a perspective view of the interior of the exposure device according to an embodiment of the present invention.

FIG. 4 is an enlarged perspective view of the interior of the exposure device according to an embodiment of the present invention.

FIG. 5 is a perspective view of the second enclosing member according to an embodiment of the present invention.

FIG. 6 is cross-sectional views of the exposure device according to an embodiment of the present invention in the plane A of FIG. 2.

FIG. 7 is other cross-sectional views of the exposure device according to an embodiment of the present invention in the plane A of FIG. 2.

FIG. 8 is a schematic wiring diagram of the TFT substrate having an array of organic EL light emitting elements according to an embodiment of the present invention.

FIG. 9 is schematic wiring diagrams for explaining the wiring board provided separately from the TFT substrate according to an embodiment of the present invention.

FIG. 10 is a cross-sectional view showing the structure around a light emission part of the array of organic EL light emitting elements according to an embodiment of the present invention.

FIG. 11 is a schematic illustration showing a structure of a prior art color image forming apparatus.

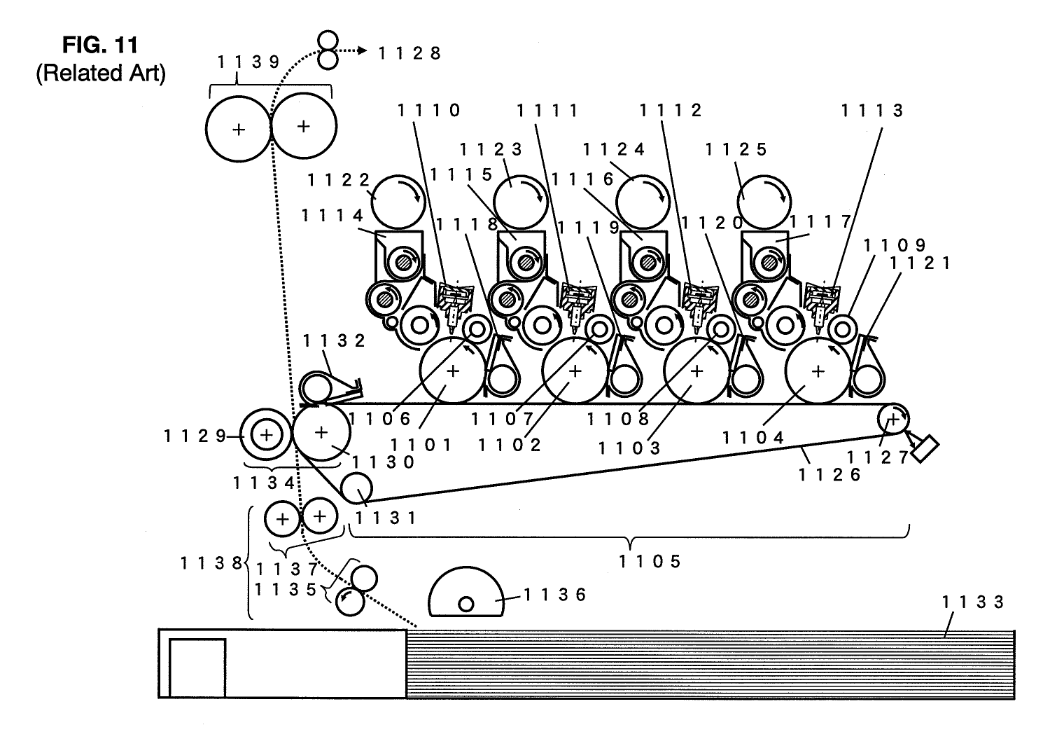

FIG. 12 is a schematic illustration showing a structure of a prior art exposure device.

### DETAILED DESCRIPTION OF THE INVENTION

Embodiments of the present invention are described hereafter with reference to the drawings.

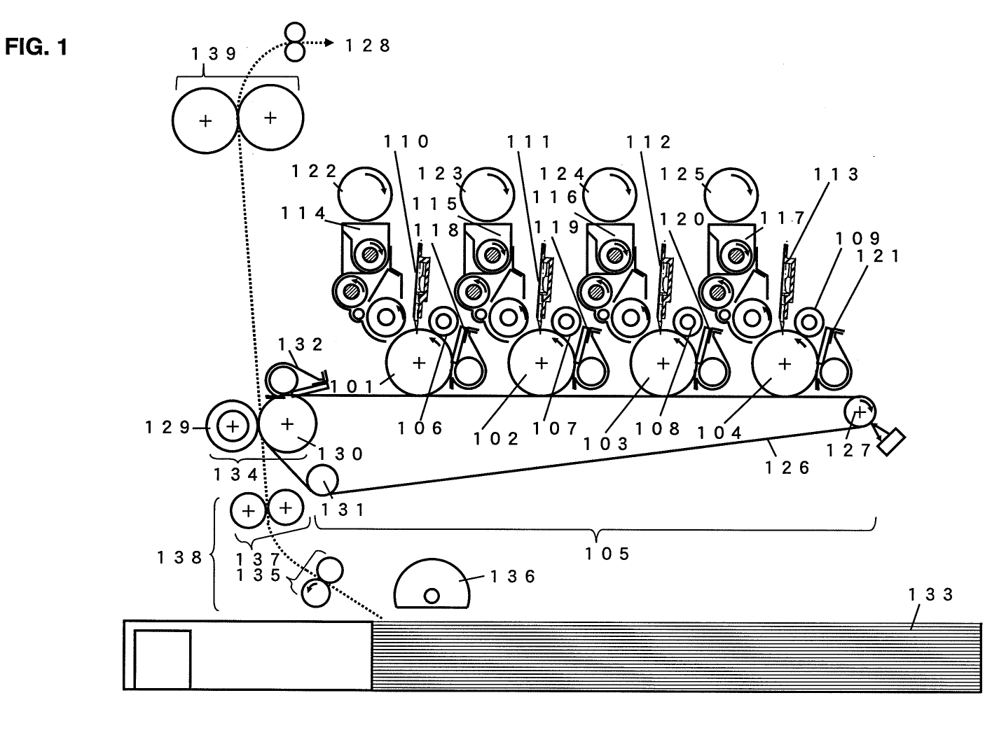

FIG. 1 shows the structure of a color image forming apparatus using the exposure device according to an embodiment of the present invention.

In FIG. 1, four image forming bodies or photosensitive bodies 101, 102, 103, and 104 and a transfer unit 105 extended over them are shown. Charging devices 106, 107, 108, and 109, exposure devices 110, 111, 112, and 113, developing devices 114, 115, 116, and 117, photosensitive body cleaning devices 118, 119, 120, and 121 are provided around the photosensitive bodies 101, 102, 103, and 104, respectively.

Developing agent storages 122, 123, 124, and 125 store the corresponding color toners to the developing devices 114, 115, 116, and 117, respectively. The stored toners are supplied to the developing devices 114 to 117 in the manner that the image recorded on paper has a nearly uniform density.

The transfer unit 105 comprises a belt transfer element 126, a drive roller 127 for rotating and transferring the belt transfer element 126, a press roller 129 for pressing the belt transfer element 126 via a recording paper 128, a support roller 130 positioned on the opposite side to the drive roller 127, and a tension roller 131 for tensing the belt transfer element 126 during the image forming so as to flatten the surface of the belt transfer element that abuts or faces the photosensitive bodies 101 to 104. In this embodiment, the belt transfer element 126 is a so-called intermediate transfer element on the surface of which a toner image is directly placed before it is transferred to a recording paper. Instead, for example, the belt transfer element 126 can be a transfer paper conveyer on which paper is placed by suction and a toner image is placed on the paper.

The transfer unit 105 is provided with a belt cleaning device 132 for removing so-called residual toner that was not transferred to the recording paper 128 and remains on the surface of the belt transfer element 126.

The color image forming apparatus shown in FIG. 1 further comprises a paper feed cassette 133 for storing the recording paper 128, a feed roller 135 for feeding the recording paper 128 from the paper feed cassette 133 to a recording paper transfer part 134 consisting of the press roller 129 and support roller 130, a paper feed part 138 consisting of a pickup roller 136, a resist roller 137, and others, and a fixing device 139 for fixing the toner image transferred to the surface of the recording paper 128.

The image forming process using the above structure is described in detail hereafter. Here, the belt transfer element 126 is an intermediate transfer element.

First, the photosensitive body 101 is uniformly charged by the charging device 106 and exposed by the exposure device 110. An electrostatic latent image formed is developed using a single color toner.

The toner image, or the visualized latent image, is transferred to the belt transfer element 126 at the position where it faces or is in contact with the belt transfer element 126. As this first toner image proceeds to the point where it makes contact with the photosensitive body 102, another color toner image formed on the surface of the photosensitive body 102 in the same manner as the first toner image is transferred on top of the first toner image as the second toner image in a timely manner. Then, the third and fourth toner images are similarly transferred and superimposed. Finally, the four-color superimposed image is obtained.

The superimposed image formed on the belt transfer element 126 is transferred to the recording paper 128 all at once at the recording paper transfer part 134 consisting of the press roller 129 and support roller 130 and fixed on the recording paper 128 by the fixing device 139, forming a color image on the recording paper 128.

The image forming apparatus according to this embodiment is different from the prior art image forming apparatus in the structure of the exposure devices 110, 111, 112, and 113. These exposure devices use an organic EL array exposure head in which organic EL light emitting elements are arranged in a row in the axis direction of the photosensitive body.

With this structure, the organic EL array exposure head has a compact size because of a shorter optical path than the laser scanning optical system and can be positioned closer to the photosensitive body so that the entire device can advantageously be downsized. Furthermore, compared with the line head type LED array exposure device, because the enclosing members constituting an enclosure (also called housing) have a nearly flat form, a further downsized and flattened structure is available, the degree of freedom of system design is improved, and the entire device can further be downsized.

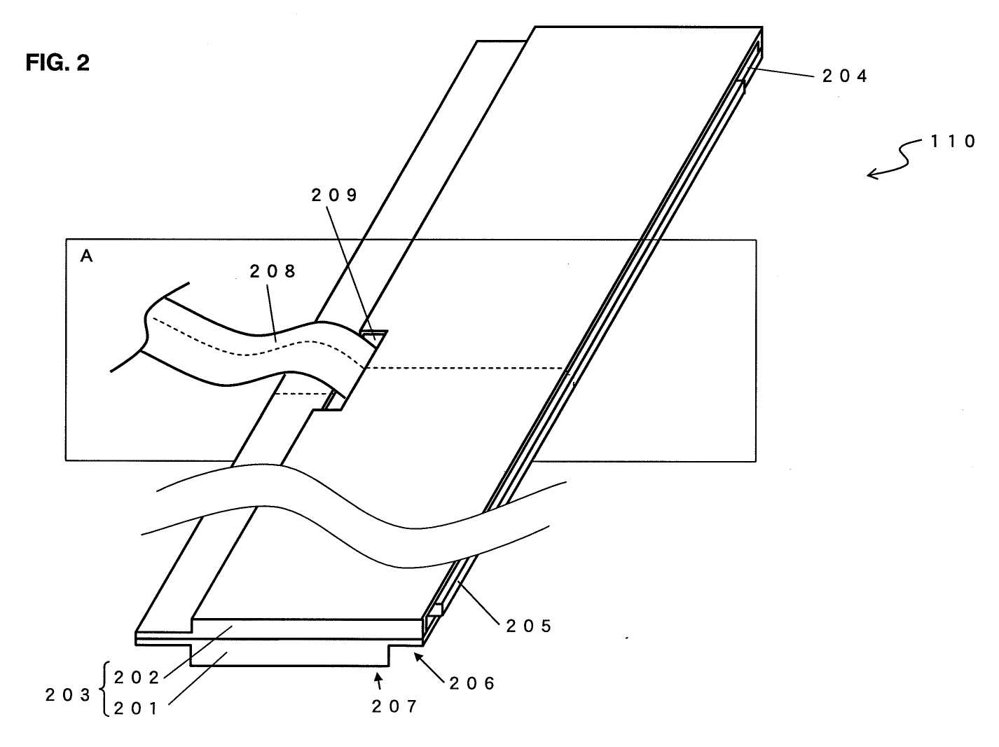

FIG. 2 is an enlarged perspective view schematically showing the exposure device 110 according to this embodiment.

The exposure devices 111, 112, and 113 have the same structure as the exposure device 110.

In FIG. 2, a nearly flat first enclosing member 201 and a nearly flat second enclosing member 202 are faced and assembled each other to constitute a housing. A TFT substrate that is a light emitting element substrate having organic EL light emitting elements is housed in an enclosure 203. An optical path opening 204 that is an opening for withdrawing light is formed on at least one side of the first and second enclosing members 201 and 202 in the end face direction, providing the optical path from the exposure device to the photosensitive body situated outside the exposure device. A gradient index rod lens array 205 is mounted in the optical path opening 204 near the photosensitive body. The housing 203 is smaller in contour at the part 206 where the gradient index rod lens array 205 is mounted than the remaining part. In this embodiment, the first enclosing member 201 is L-shaped at the part 206. The mounting part 206 is smaller than the TFT substrate storing part 207 in the width direction of the board. With the part 206 for mounting the rod lens array 205 being smaller than the remaining part, the exposure device occupies a smaller space around the photosensitive body, which facilitates the positioning of the exposure device.

The second enclosing member 202 has an opening 209 for withdrawing a cable 208.

The gaps at both ends of the opening 209 and optical path opening 204 in the longitudinal direction are sealed with a flexible sheet material or resin. The first enclosing member 201 is particularly made of a nonmagnetic material such as Al and formed by any processing method such as extrusion, die-casting, and sheet metal processing. The second enclosing member 202 is made of a resin and formed by resin molding. The first and second enclosing members 201 and 202 are made of opaque materials, for example black materials or materials with black finishing.

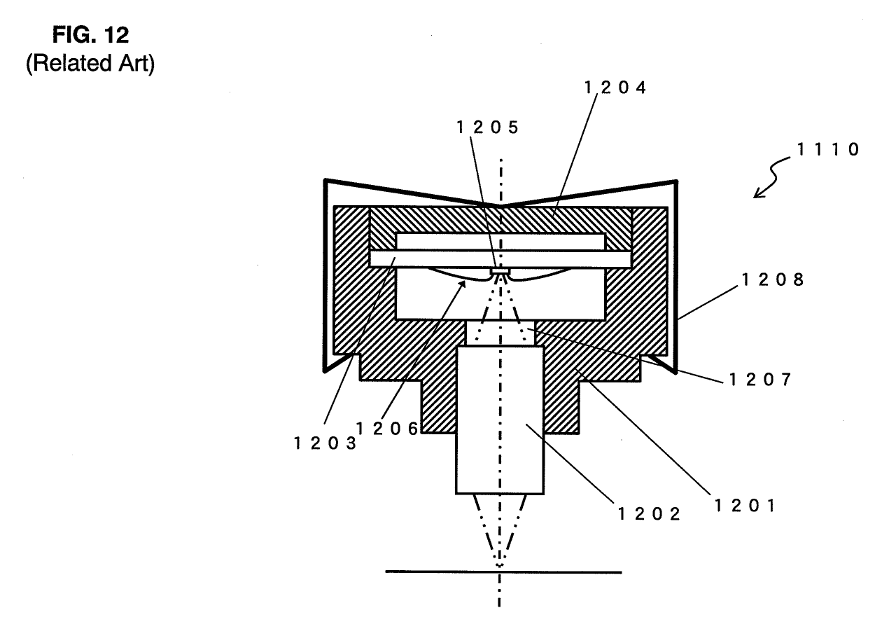

With the above structure, two separable enclosing members are assembled to form the optical path opening 204 in the end face direction of the enclosing members. This eliminates the secondary processing to form an optical path opening after the enclosing members are formed. In addition, the housing constituted by two nearly flat enclosing members can be more flattened than the prior art housing with which the optical path opening is formed at the bottom of the enclosing member (FIG. 12).

As shown in FIG. 1, the exposure device 110 is provided near the developing device 114. Therefore, magnetized carriers from the developing device 114 are floating near the exposure device. Thus, if the exposure device has any magnetic enclosing members, the exposure device attracts the carriers and causes them to adhere to the gradient index rod lens array 205. Consequently, the optical path is blocked by the carriers and the photosensitive body is not illuminated with a necessary amount of light. The nonmagnetic enclosing members 201 and 202 eliminate such problems. The enclosing members can be made of a nonmagnetic material only in the part adjacent to the developing device 114.

The openings are sealed with an opaque and flexible sheet material or resin. This eliminates the provision of another sealing member, reducing components and thus cost. Furthermore, black enclosing members and sealing materials prevent flare light. The exposure device and photosensitive body are placed close to each other. When the exposure device exposes the photosensitive body, the light is partly reflected by the photosensitive body and such light returns to the exposure device from the photosensitive body. Using black enclosing members and sealing material in the exposure device prevents the enclosing members and others from further reflecting the light from the photosensitive body and disturbing the image on the photosensitive body.

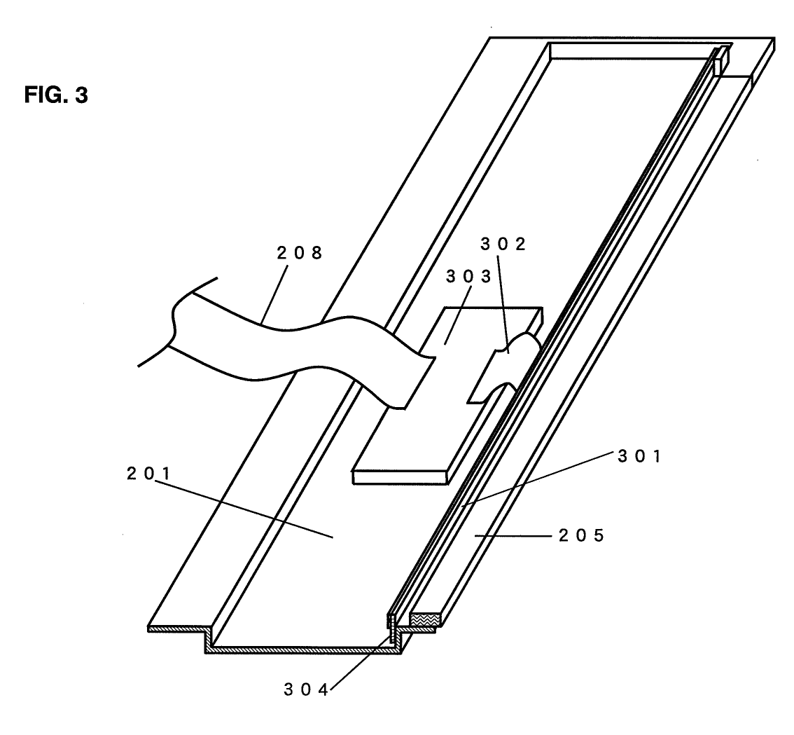

FIG. 3 is a schematic perspective view of the first enclosing member and the interior of the enclosure of the exposure device 110 shown in FIG. 2 where the second enclosing member 202 is removed.

In FIG. 3, the enclosure contains a TFT substrate 301 having organic EL light emitting elements and a relay board 303 electrically connected to the TFT substrate 301 via a flexible wire 302 for connecting to the circuit of the TFT substrate 301 a circuit as an external drive means (not shown) that is an external device for controlling light emission of the exposure device in an image forming apparatus in which the exposure device is installed via an inter-device cable 208. Both the TFT substrate 301 and the gradient index rod lens array 205 are mounted on and supported by the first enclosing member 201. The TFT substrate 301 abuts the first enclosing member 201 at the opposite surface to the surface 304 where the organic EL light emitting elements are formed.

With the above structure, the TFT substrate 301 having light emitting elements and the gradient index rod lens array 205 are mounted on and supported by the same enclosing member. This ensures the accuracy of assembly of the exposure device and the accuracy is preserved after the assembly compared with the structure in which they are separately mounted on and supported by the first enclosing member or second enclosing member.

It is useful for a flattened exposure device to downsize the TFT substrate 301 in the sub-scanning direction as much as possible. The TFT substrate 301 abuts the first enclosing member at the opposite surface to the surface 304 where the organic EL light emitting elements are formed. Therefore, there is no need of reserving an area to abut the first enclosing member 201 on the surface 304 where the organic EL light emitting elements are formed. Then, the TFT substrate 301 can be downsized and the exposure device can accordingly be flattened. Furthermore, the TFT substrate yield is increased, leading to reduced cost.

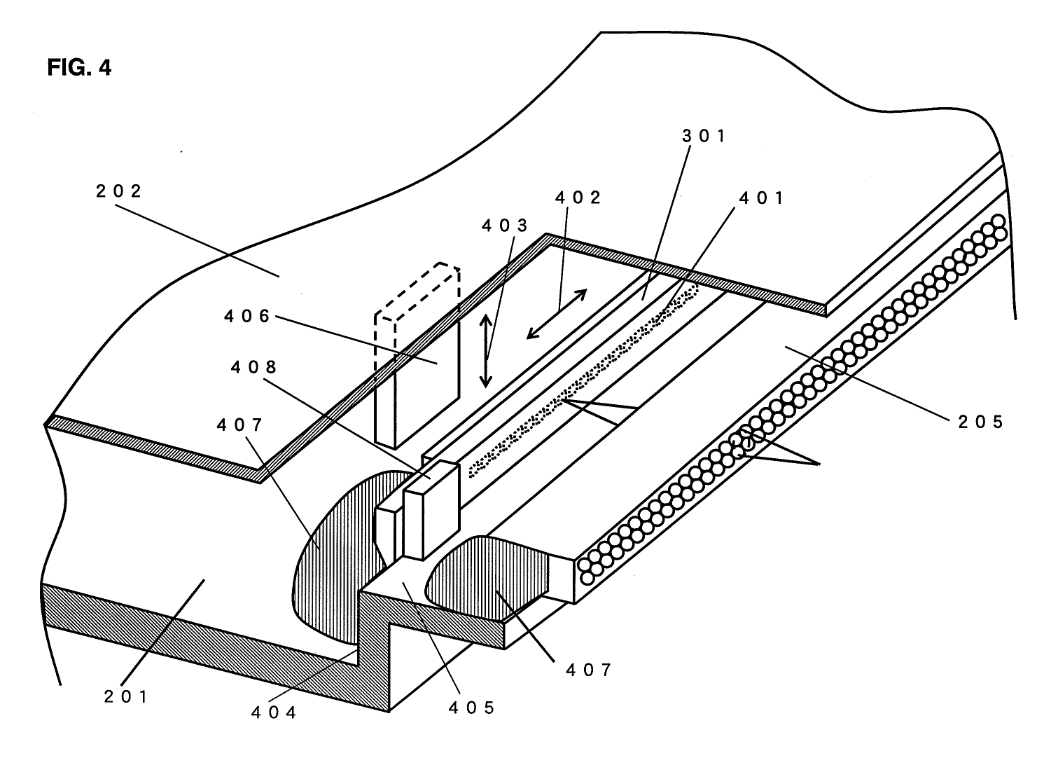

FIG. 4 is an enlarged view showing the assembled structure of the first and second enclosing members 201 and 202 and the TFT substrate 301 having light emitting elements.

In FIG. 4, the TFT substrate 301 on which multiple organic EL light emitting elements 401 are arranged in a row is interposed between the first and second enclosing members 201 and 202. However, it is supported only by the first enclosing member 201. The TFT substrate 301 is supported only at the bottom part in the width direction 403 of the board surface at least in the section in the row direction 402 where the light emitting elements 401 are arranged. The surface 404 which the TFT substrate 301 is mounted on and supported by is orthogonal to the surface 405 which the gradient index rod lens array 205 is mounted on and supported by. The top of the TFT substrate 301 protrudes above the surface 405. The TFT substrate 301 and gradient index rod lens array 205 are spaced for the working distance of the rod lens array 205. The first enclosing member 201 supporting the TFT substrate 301 and rod lens array 205 has a thickness of 0.2 to 0.6 mm.

The second enclosing member 202 has at least one or more columns (called support) 406 arranged in the longitudinal direction on the opposite side of the TFT substrate 301 to the light emission side for supporting the surface of the first enclosing member 201 that is the other facing enclosing member. In this embodiment, the support 406 is provided on the opposite side of the TFT substrate 301 to the rod lens array 205. The support 406 can be provided either to the first enclosing member 201 or to the second enclosing member 202.

The TFT substrate 301 and gradient index rod lens array 205 are attached to the first enclosing member 201 at both ends in the main scanning direction using adhesive 407. The adhesive 407 is made of a UV curing resin material.

The TFT substrate 301 having light emitting elements and the gradient index rod lens array 205 are sealed with an opaque flexible sheet. The flexible sheet has a thickness of less than 0.1 mm.

At least one projection 408 for holding the TFT substrate 301 throughout the area in the width direction is provided near the ends of the surface 405 of the enclosing member 201 which the gradient index rod lens array 205 is mounted on and supported by in the longitudinal direction 402. The projection 408 has a side that is partly in plane with the surface 404 of the enclosing member 201 which the TFT substrate 301 is mounted on and supported by. With the projection 408 and surface 404 being in plane with each other, the TFT substrate 301 is supported both at the top and at the bottom in the ends in the direction 402 of the row of light emitting elements 401.

The above structure yields the following effects.

As the enclosing member is made thinner, it loses the rigidity and has a risk of being deflected. Therefore, when the enclosing member itself has a simple flat thin form, it is difficult to maintain the positional accuracy of the light emitting elements and optical lens because of deflection. On the other hand, when the enclosing member is in the form of a back-to-back structure having planes orthogonal to each other, improved rigidity serves to reduce the deflection. Furthermore, the enclosing member having a right angle allows the TFT substrate 301 emitting light at a right angle to the board surface and the rod lens array 205 having the optical axis in the light emission direction to be positioned close to each other. In addition, they are bonded and fixed at the longitudinal surfaces, easily maintaining a high level of positional accuracy of the optical members.

After the TFT substrate 301 is mounted on the first enclosing member 201, the gradient index rod lens array 205 can be mounted at the working distance with no interfere from the enclosing member 201 on the optical axis of the rod lens array 205 during the optical adjustment of focal length of the gradient index rod lens array 205 or regardless of the accuracy of form of the enclosing member 201.

The enclosing member 201 has a thickness of 0.2 mm to 0.6 mm, realizing a back-to back structure in a small space to ensure strength against deflection. In this way, the optical elements can stably be held in a small space with accuracy.

The support 406 prevents the enclosing member from being deformed when the exposure device is subject to an external force, thus preventing the contained TFT substrate 301 having light emitting elements from being damaged.

The support is provided on the opposite side of the TFT substrate 301 having light emitting elements to the light emission side. Therefore, the support does not interfere with the optical path; the photosensitive body is illuminated with a given amount of light.

The TFT substrate 301 and gradient index rod lens array 205 are sealed with a flexible sheet, preventing the toner from adhering to and contaminating them. The flexible sheet is made of an opaque black material, preventing flare light. The flexible sheet has a thickness of less than 0.1 mm, flattening the exposure device.

The projection 408 on the lens mounting/support surface of the enclosing member 201 easily makes contact with a part of the TFT substrate 301 throughout the area in the width direction to hold the TFT substrate 301. The cantilever structure does not extend over the entire board, reducing the wobbling of the TFT substrate 301 and improving the accuracy of support.

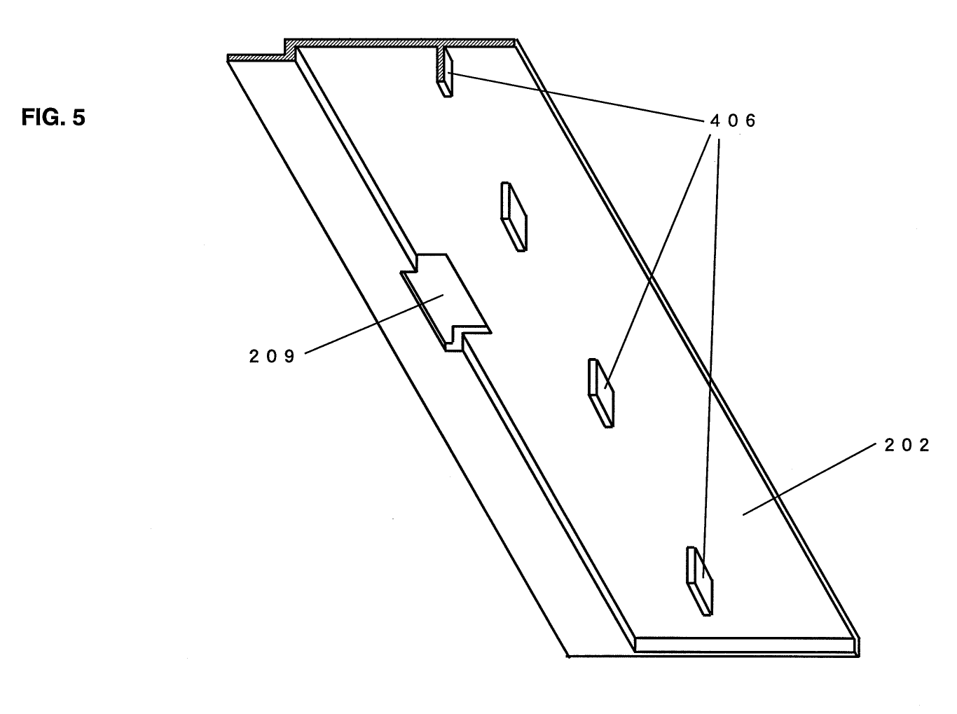

FIG. 5 is a schematic perspective view of the second enclosing member 202.

In FIG. 5, at least one or more supports 406 as above described are arranged in the longitudinal direction on the second enclosing member 202.

An opening 209 is formed. The cable 208 extended from the relay board 303 is connected to an external drive control means through the opening 209. Here, the opening 209 can be formed in the first enclosing member 201 without any problems instead of the second enclosing member 202.

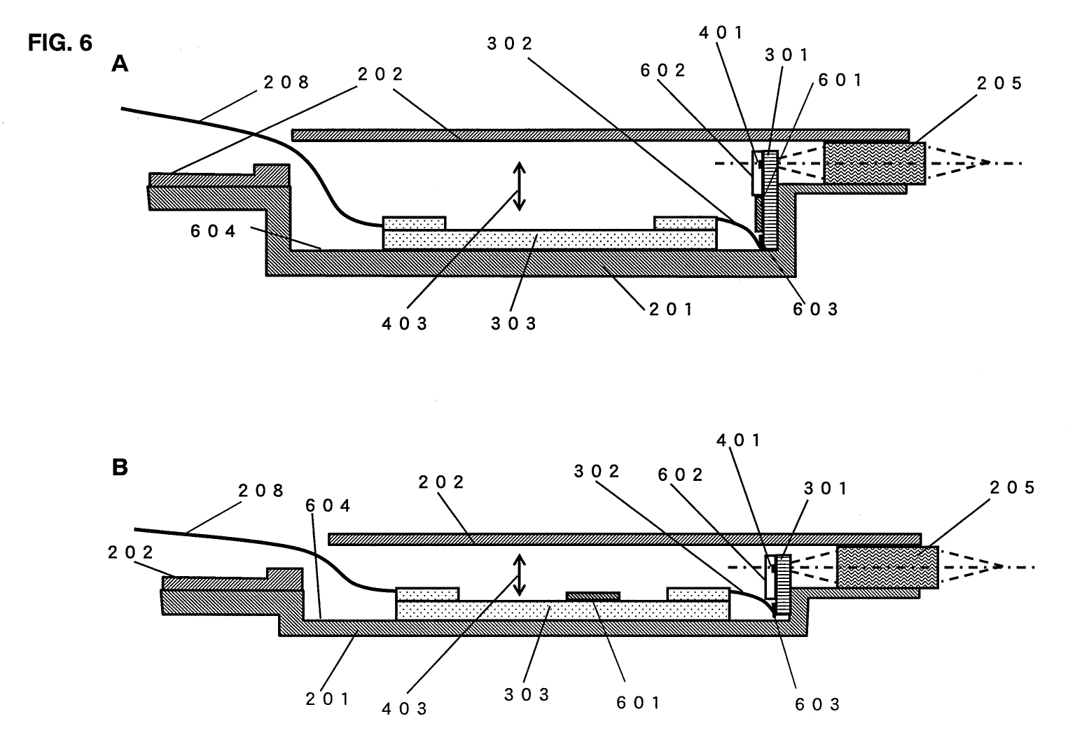

FIG. 6 is a cross-sectional view in the plane A of FIG. 2. FIG. 6 shows the constitution of the gradient index rod lens array 205, TFT substrate 301 having organic EL light emitting elements 401, relay board 303, and an flexible wire 302 connecting the TFT substrate 301 and the others in the housing constituted by the first and second enclosing members 201 and 202. In FIG. 6A, a drive circuit 601 for electrically driving the individual light emitting elements of the organic EL light emitting elements 401 for light emission is provided on the TFT substrate 301. The drive circuit 601 is provided on the opposite surface of the TFT substrate 301 to the surface that is mounted on the first enclosing member like the light emitting elements 401. In this embodiment, the drive circuit 601 is directly below a sealing glass 602 that seals the light emitting elements 401. In FIG. 6B, the drive circuit 601 is provided on the relay board 303.

In both FIGS. 6A and 6B, the flexible wire 302 is connected to the end 603 of a signal line provided locally at one side of the TFT substrate 301. The flexible wire 302 is extended in the direction that the organic EL light emitting elements 401 of the TFT substrate 301 are provided or inward of the TFT substrate.

The TFT substrate 301 and relay board 303 are supported by the first enclosing member 201 in the manner that the TFT substrate 301 is behind the gradient index rod lens array 205 and the relay board 303 is behind the TFT substrate 301 in the direction and orientation of light emission. When the device is seen from the light emission side, the relay board 303 is smaller than the TFT substrate 301 in the width direction 403 in the projected contours of the boards. In this embodiment, the TFT substrate 301 is placed along the width direction 403 and the relay board 303 is placed along the surface 604 of the first enclosing member 201. Therefore, the dimension of the relay board 303 in the width direction 403 is the thickness of the relay board 303 and much smaller than the dimension of the TFT substrate 301 in the width direction 403.

The pattern-wired signal line on the relay board 303 is wider than the pattern-wired signal line on the TFT substrate 301 for signals electrically connected to the TFT substrate 301 via the flexible wire 302. The cross-sectional area of the signal line on the relay board 303 is larger than the cross sectional area of the signal line on the TFT substrate 301.

The relay board 303 has a terminal for the connection to the external drive means, to which one end of the inter-device cable 208 is connected.

The first enclosing member 201 has a larger thickness at the part where the gradient index rod lens array 205 is placed than at the remaining part.

With the above structure, the flexible wire 302 and relay board 303 can be placed within the width of the TFT substrate 301 in the sub-scanning direction, flattening the exposure device.

If the flexible wire 302 is extended outward of the TFT substrate 301 unlike the above structure, a space for extending the flexible wire 302 has to be reserved in the enclosure, which is disadvantageous for flattening and downsizing the exposure device. In addition, the flexible wire 302 is folded in a very small space; therefore, the contact surface between the flexible wire 302 and the signal distribution terminal 603 is stressed, leading to reduced reliability.

The board to be stored in the enclosure is divided into two boards, the TFT substrate 301 and the relay board 303. The TFT substrate 301 is placed behind the gradient index rod lens array 205 and the relay board 303 is placed behind the TFT substrate 301. In this way, the space necessary for storing the board can have a reduced height. In other words, the TFT substrate 301 having light emitting elements is mounted in a specific direction/orientation as shown according to the relationships between the direction/orientation of formation of light emitting elements and the direction/orientation of light emission. Therefore, when this board has other electric circuits thereon, the board becomes larger (taller). The enclosure accordingly becomes larger in height (the distance between the first and second enclosing members in FIG. 6). On the other hand, with the structure of this embodiment, the height of the space necessary for storing the board can be as small as the dimension of the board having light emitting elements that is essential for an exposure device. Then, the enclosure can be flattened nearly to the minimum.

The pattern-wired signal line on the relay board 303 is wider than the signal line on the TFT substrate 301 so that the signal line has a larger cross-sectional area and a reduced electric resistance per unit length. With regard to signal line wiring, a larger wiring area is used on the relay board 303 on which a relatively large wiring area is easily available, reducing the electric resistance of the signal line, enabling the signal to be efficiently transmitted. Furthermore, multiple such circuit boards can be used to constitute electric circuits for light emission of the light emitting elements so that the space necessary for storing the board does not become larger but rather become smaller in height while achieving efficient signal transmission.

The enclosure has a smaller thickness at the optical path opening of the first enclosing member 201 or where the gradient index rod lens array 205 is placed. In this way, the exposure device is thinner at the leading end in the exposure direction. Therefore, the leading end of the exposure device can be placed in a very small area near the photosensitive body where the developing roller and charging roller are placed close together within the image forming apparatus.

As shown in FIG. 6B, the drive circuit 601 is placed on the relay board 303, not on the TFT substrate 301; the exposure device can be reduced in thickness up to the minimum dimension of the TFT substrate 301 in the width direction 403.

The exposure device can have a terminal for the connection to the external drive means outside the enclosure.

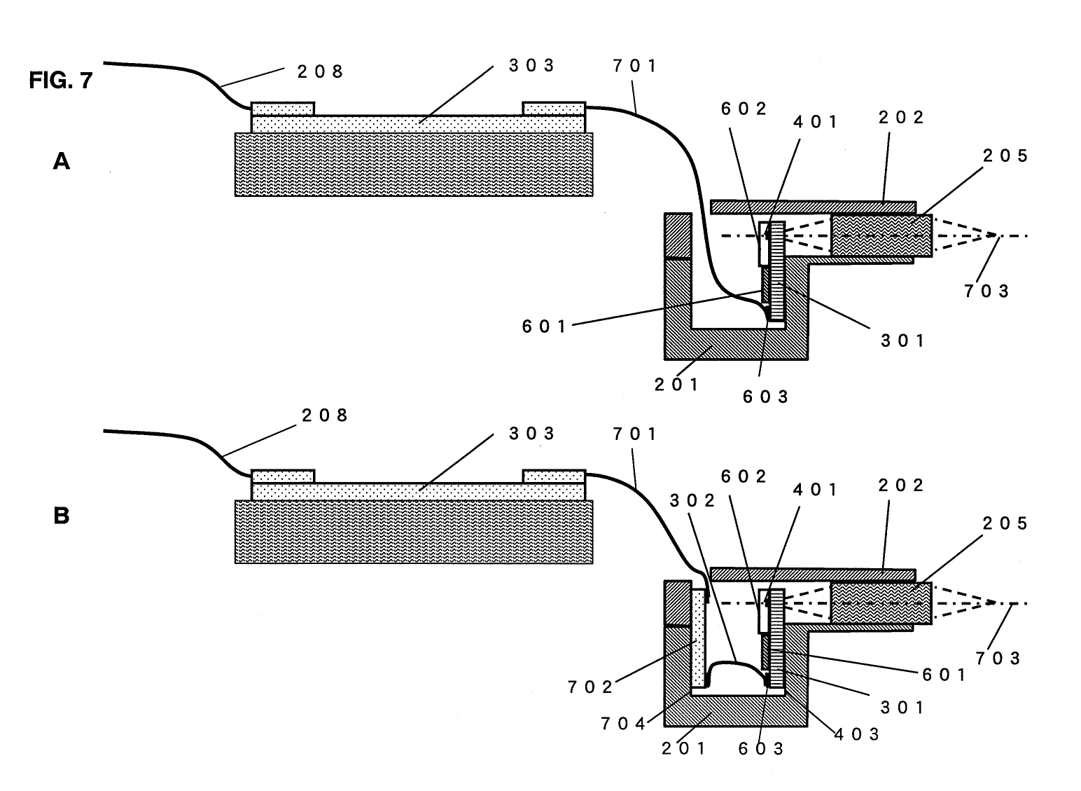

FIG. 7 is a cross-sectional view of such an exposure device in the plane A of FIG. 2. The figure shows the configuration of the gradient index rod lens array 205, the TFT substrate 301 having organic EL light emitting elements 401, TFT substrate 301, and an extension cable 701 in the housing constituted by the first and second enclosing members 201 and 202, and the relay board 303 outside the enclosure. In FIG. 7B, compared to FIG. 7A, a printed (patterned) wiring board 702 serving as an electric circuit for light emission of the light emitting elements is provided outside the TFT substrate 301 having organic EL light emitting elements 401.

In FIG. 7, the relay board 303 is provided in a relatively large area outside the enclosure that is available within the image forming apparatus in which the exposure device is installed. The relay board 303 has a terminal for the connection to the external drive means, to which one end of the inter-device cable 208 is connected. The relay board 303 is connected to the TFT substrate 301 via an extension cable 701 made of a flexible wire.

Here, the connection can be made via a printed wiring board 702 provided outside the TFT substrate 301 as shown in FIG. 7B.

The pattern-wired signal line on the printed wiring board 702 in FIG. 7B is wider than the pattern-wired signal line on the TFT substrate 301 for signals electrically connected to the TFT substrate 301 via the flexible wire 302. The signal line on the printed wiring board 702 has a larger cross-sectional area than the signal line on the TFT substrate 301.

With the above structure, the extension cable 701 has a terminal provided outside the enclosure and connected to the signal line from the external drive means. In this way, the dimension of the enclosure in the optical axis direction 703 can be minimized by eliminating the wiring and connectors and other terminals for external connections from the enclosure. Furthermore, the inter-device cable for the connection to the external drive means and the external connection terminal connected to the inter-device cable can be placed in a relatively larger area available in the image forming apparatus in which the exposure device is installed. This facilitates the positioning of the exposure device in the image forming apparatus. In addition, the total device cost can be reduced by using inexpensive inter-device cable line materials and connectors and other wiring members relatively irrelevantly to their dimensions and shapes. Furthermore, as shown in FIG. 7B, the printed wiring board 702 is mounted on and supported by the opposite surface 704 to the surface 403 on which the TFT substrate 301 is mounted. In this way, the dimension of the enclosure in the optical axis direction 703 can be suppressed even if the printed wiring board 702 is provided within the enclosure.

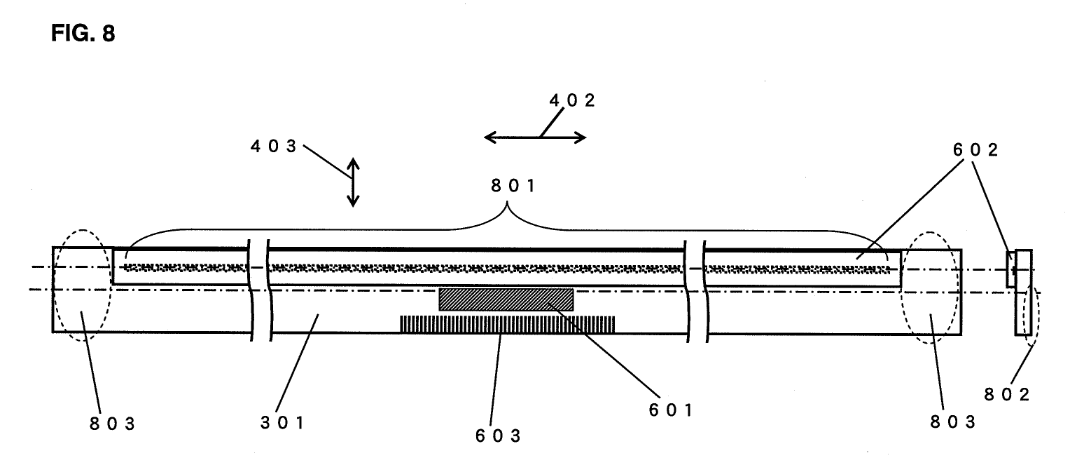

FIG. 8 is a schematic illustration of the TFT substrate 301 having an array of organic EL light emitting elements 801.

In FIG. 8, the array of organic EL light emitting elements 801 is positioned on the TFT substrate 301 in the manner that the center line of the array of organic EL light emitting elements 801 is shifted to either side in the end face direction in relation to the center line of the TFT substrate 301 and the array of organic EL light emitting elements 801 is arranged near the end in the width direction 403 of the TFT substrate 301 along the direction 402 orthogonal to the width direction 403.

The end 603 of the signal line wire is placed on the surface of the TFT substrate 301 where the array of organic EL light emitting elements 801 is provided. The signal wire end 603 is placed near the opposite end face to the array 801 in the width direction 403. The signal wire end 603 is connected to the flexible wire 302 for the connection to the relay board 303.

The opposite surface to the surface where the array of organic light emitting elements 801 and signal wire end 603 are provided abuts the enclosing member. Naturally, the opposite surface to the surface where the array of organic light emitting elements 801 is formed abuts the enclosing member at a partial area 802 so that the light emitted from the array of organic EL light emitting elements is not blocked.

The array of organic EL light emitting elements 801 is sealed with a sealing glass 602. Here, the TFT substrate 301 has a large space at either end 803 in the main scanning direction where neither the array of organic EL light emitting elements 801 nor the sealing glass 602 is present.

With the above structure, the array of organic EL light emitting elements 801 is shifted to either side of the TFT substrate 301 in the end face direction. A large area 802 is available for abutting against the enclosing member. Therefore, the assembly is facilitated and the accuracy of assembly is improved. Then, no support is made at the other side and, for that, the TFT substrate 301 can be reduced in size, downsizing the exposure device.

In other words, for the same size substrate not having the above structure, namely having the array of organic EL light emitting elements 801 placed nearly in the center of the TFT substrate, the area 802 for abutting against the enclosing member becomes smaller, making the assembly difficult and reducing the accuracy of assembly and strength. In such a structure, it is difficult to hold the TFT substrate 301 with accuracy when it is mounted only at one side.

However, with regard to the provision of light emitting elements on a substrate end, when an array of LED light emitting elements is used as described in the prior art example, the LED light emitting elements and drive circuit has to be connected by wire bonding. If the LED light emitting elements are placed at significantly small pitches such as 600 dpi (42.3 μm pitch) and 1200 dpi (21.2 μm pitch), it is difficult to extend the wire from the LED light emitting elements in one direction on one side. Therefore, the wire is extended from the light emitting elements on both sides. Consequently, the array of LED light emitting elements is placed nearly in the center of the LED light emission substrate and it is difficult to place it to the end.

On the other hand, the wiring on the array of organic EL light emitting elements 801 and TFT substrate 301 in this embodiment is made in the semiconductor process. The wire is extended in one direction on one side, enabling the array of light emitting elements 801 to be placed at the end of the TFT substrate 301.

The end zones 803 of the TFT substrate 301 in the longitudinal direction are used for the bonding to the first enclosing member 201, which facilitates the mounting of the TFT substrate 301 to the enclosing member and ensures the bonding strength.

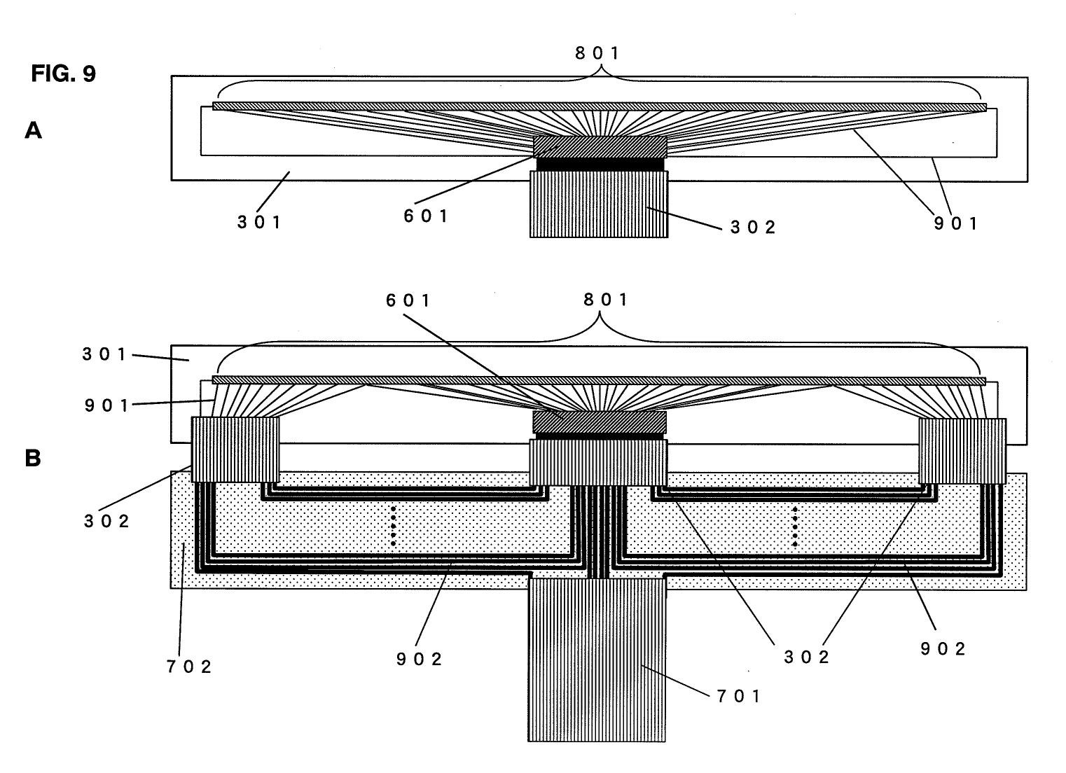

FIG. 9 is a schematic diagram for explaining the printed wiring board 702 provided outside the TFT substrate 301, showing the printed wiring board 702 and the corresponding wiring pattern on the TFT substrate 301. FIG. 9A shows the wiring pattern on the TFT substrate 301 in the case that the printed wiring board 702 is not used (for example the structure in FIG. 7A). FIG. 9B shows the wiring pattern on the TFT substrate 301 and the connection to the printed wiring board 702 in the case that the printed wiring board 702 is used (for example the structure in FIG. 7B). In FIG. 9A, the array of organic EL light emitting elements 801 and drive circuit 601 on the TFT substrate 301 are pattern-wired by signal lines 90 on the TFT substrate 301 to connect the individual light emitting elements and the corresponding drive circuit terminals. In this embodiment, one drive circuit 601 is provided in the center of the array of organic EL light emitting elements 801 in the longitudinal direction. The signal lines 901 to light emitting elements at the end of the array of organic EL light emitting elements 801 are longer than the signal lines 901 to light emitting elements in the middle. If the signal lines 901 to light emitting elements at the end have an increased width for suppressing the voltage drop, the TFT substrate 301 is increased in size.

In FIG. 9B, the array of organic EL light emitting elements 801 and drive circuit 601 on the TFT substrate 301 are pattern-wired in the manner that, for a group of light emitting elements near the drive circuit 601 in the array of organic EL light emitting elements 801, the individual light emitting elements in that group and the corresponding drive circuit terminals are pattern-wired on the TFT substrate 301 and for a group of light emitting elements away from the drive circuit 601 in the array of organic EL light emitting elements 801 (near either end in FIG. 9B), the individual light emitting elements in that group and the corresponding drive circuit terminals are electrically connected via signal lines 902 on the printed wiring board 702 connected by flexible wires 302, bypassing the TFT substrate 301.

Here, with regard to the printed wiring board 702 and flexible wires 302, for signals electrically connected to the TFT substrate 301 via the flexible wires 302, the signal lines 902 patterned-wired on the printed wiring board 702 are wider than the signal lines 901 pattern-wired on the TFT substrate 301 and, therefore, the signal lines 902 on the printed wiring board 702 have a larger cross-sectional area than the signal lines 901 on the TFT substrate 301.

With the above structure, at least some of multiple light emitting elements receive electric driving signals from the drive circuit 601 for their light emission via at least one wire outside the TFT substrate 301. The signal line from the drive circuit 601 is provided within the TFT substrate 301 for light emitting elements near the drive circuit 601 and the signal line is provided outside the TFT substrate 301 for light emitting elements away from the drive circuit 601. In this way, the TFT substrate 301 is not increased but rather reduced in size while reducing the electric resistance of wire.

A relatively large wiring area is available outside the TFT substrate 301. The signal line can be made thick to reduce the electric resistance per unit length. For light emitting elements away from the drive circuit 601, such signal lines are used in wiring to near them. In this way, the wiring resistance from the drive circuit 601 to the light emitting element can be reduced compared to the use of a relatively long wire in a limited wiring area in the TFT substrate 301. Accordingly, the wiring within the TFT substrate 301 is reduced and the TFT substrate 301 itself can be downsized.

The wiring on the printed wiring board 702 can be applied to the relay board 303 when the relay board 303 is provided within the enclosure (for example the structure in FIG. 6) and the same effect is obtained.

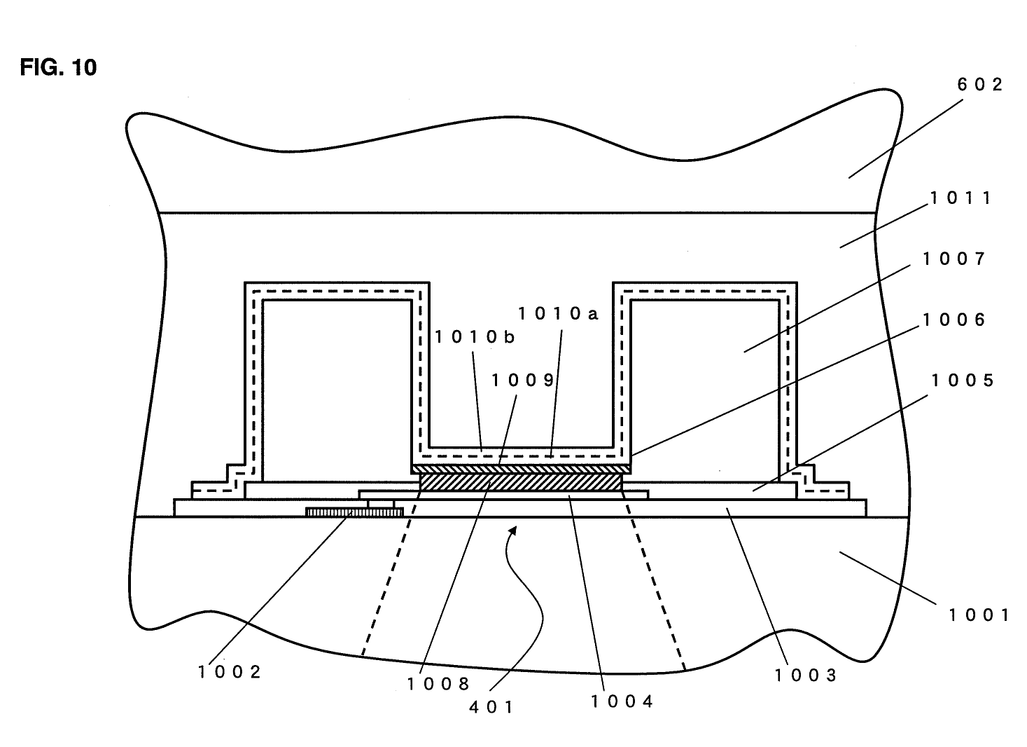

FIG. 10 is a cross-sectional view around a light emitting element 401 of the array of organic EL light emitting elements 801 shown in FIG. 8.

In FIG. 10, a light emitting element 401 of the array of organic EL light emitting elements 801 is provided with a polysilicon TFT (thin-film transistors) 1002 having a thickness of 50 nm for controlling light emission of the light emitting element 401 for example on a glass substrate 1001 having a thickness of 0.5 mm. More specifically, an SiO₂ insulating film 1003 having a thickness of approximately 100 nm is formed on the glass substrate 1001 except for a contact hole above the TFT 1002. The light emitting element 401 is provided with an ITO positive electrode 1004 having a thickness of 150 nm for the connection to the TFT 1002 via the contact hole.

On the other hand, another SiO₂ insulating film 1005 having a thickness of approximately 120 nm is formed on the area other than the light emitting element 401. A polyimide bank 1007 having a thickness of 2 μm with a hole 1006 corresponding to the light emitting element 401 is formed on the insulating film 1005.

A hole injected layer 1008 having a thickness of 50 nm and a light emission layer 1009 having a thickness of 50 nm are formed in the hole 1006 of the bank 1007 in this order from the positive electrode 1004. A Ca first negative electrode layer 1010a having a thickness of 100 nm and an Al second negative electrode layer 1010b having a thickness of 200 nm are formed in this order to cover the top surface of the light emission layer 1009, the inner wall of the hole 1006, and the outer wall of the bank 1007.

These are covered with a cover glass 602 having a thickness of approximately 1 mm via inert gas 1011 such as nitrogen gas to constitute a light emitting element 401 of the array of organic EL light emitting elements 801. Here, the light emitting element 401 emits light to the TFT substrate 301 side. The TFT substrate 301 abuts the first enclosing member at the opposite surface of the glass substrate 1001 to the surface where the light emitting element 401 is provided. The columns to support the housing are provided on the surface of the glass substrate 1001 where the light emitting element 401 is provided.

The materials of the light emission layer 1009 and hole injected layer 1008 can be various materials known for example from the Japanese Laid-Open Patent Application Nos. H10-12377 and 2000-323276. Such organic EL light emitting elements reduce production cost because light emitting elements are easily produced on a TFT substrate.

As described above, in this embodiment, the substrate is supported only at either one side in the width direction of the substrate surface that is orthogonal to the direction of the row and supported by only one of the enclosing members at least in the section in the direction of the row of multiple light emitting elements where the light emitting elements are arranged. Therefore, the substrate is supported by a stable one enclosing member. Even if the substrate is supported at multiple points, the substrate is subject to almost no distortion due to multipoint-support. In addition, the substrate is supported at an area on only one side in the width direction. The substrate is allowed to have a reduced size in the width direction, further flattening the exposure device.

The enclosure uses two enclosing members to form an opening serving as the optical path to the outside. The light emitting element substrate is supported behind the lens and one or multiple circuit boards are supported behind the light emitting element substrate in the illumination direction and orientation, further flattening the exposure device with low cost. In other words, two or more substrates are stored in the enclosure. Among them, the light emitting element substrate is supported behind the lens and one or multiple other circuit boards are supported behind the light emitting element substrate. In this way, the space necessary for storing the substrates can be small in height. In addition, the opening serving as the optical path is formed by two enclosing members. This eliminates the secondary processing that is necessary when the opening is formed in one enclosure member. Notched enclosing members are assembled to form an opening. There is no need of providing an area around the opening for the secondary processing. The enclosure itself can be flattened for that. Furthermore, the secondary processing for the enclosure is unnecessary and the cost for the enclosure itself is reduced.

As described above, a low cost and flattened exposure device can be realized.

The above described embodiments do not restrict the technical scope of the present invention. Various modifications and applications are available within the scope of the present invention besides the above described embodiments. Two enclosing members are used in the above described embodiment. However, three or more enclosing members can be used to form a housing. In the embodiment of FIG. 7, one printed wiring board is stored in the enclosure. This is not restrictive. Multiple printed wiring boards can be provided or some printed wiring boards can be provided outside the enclosure. Furthermore, the present invention is applicable to monochrome image forming apparatuses.

Preferable characteristics of the present invention are summarized into the following exposure device and image forming apparatus.

(1) An exposure device in which light emitting elements provided to individual pixels constituting an image are used as a light source to emit light according to image information and illuminate an external photosensitive body with the light, comprising an enclosure having one or a plurality of enclosing members and a substrate placed inside the enclosure and having a row of a plurality of light emitting elements, wherein the substrate is supported only at either one side in the width direction of the substrate surface that is orthogonal to the direction of the row and supported by only one of the enclosing members at least in the section in the direction of the row where the light emitting elements are arranged.

With this structure, the substrate is supported only at either one side in the width direction of the substrate surface that is orthogonal to the direction of the row and supported by only one of the enclosing members at least in the section in the direction of the row of a plurality of light emitting elements where the light emitting elements are arranged. Therefore, the substrate is supported by a stable one enclosing member. Even if the substrate is supported at multiple points, the substrate is subject to almost no distortion due to multipoint-support. In addition, there is no need of providing an area for supporting the substrate in the other side in the width direction where no support is made. Then, the substrate is allowed to have a reduced size in the width direction, thereby further flattening the exposure device.

As the substrate is further downsized, the substrate yield is improved, further reducing the cost. Furthermore, as the exposure device is flattened and downsized, the image forming apparatus is further downsized and has the degree of freedom of design improved.

The above effect is obtained even if the area of a substrate that is mounted on or abutting against the enclosing member is extended beyond the center line in the width direction as long as the substrate is supported by an enclosing member at only one side in the width direction of the substrate.

(2) An exposure device in which light emitting elements provided to individual pixels constituting an image are used as a light source to emit light according to image information and illuminate an external photosensitive body with the light, comprising an enclosure having one or a plurality of enclosing members and a substrate placed inside the enclosure and having a row of a plurality of light emitting elements, wherein the light emitting elements are localized on the substrate in either one side in the width direction of the substrate that is orthogonal to the direction of the row and the substrate is supported only at the other side in the width direction and supported by only one of the enclosing members at least in the section in the direction of the row where the light emitting elements are arranged.

With this structure, the light emitting elements are localized on the substrate in either one side in the width direction of the substrate and the substrate is supported only at the other side in the width direction and supported by only one of the enclosing members at least in the section in the direction of the row where the light emitting elements are arranged. As the light emitting elements are provided on the substrate in the above one side, the area for the drive circuit and other circuits can collectively be provided in the other side. Even if the substrate is supported at multiple points, the substrate is subject to almost no distortion due to multipoint-support. In addition, the substrate can be smaller in the width direction.

(3) An exposure device in which light emitting elements provided to individual pixels constituting an image are used as a light source to emit light according to image information and illuminate an external photosensitive body with the light, comprising an enclosure having one or a plurality of enclosing members and a substrate placed inside the enclosure and having a row of a plurality of light emitting elements, wherein the cable is connected to the substrate near the end of either one side in the width direction of the substrate that is orthogonal to the direction of the row and extended inward of the substrate and the substrate is supported at either one side in the width direction and supported by only one of the enclosing members at least in the section in the direction of the row where the light emitting elements are arranged.

With this structure, the cable is connected to the substrate near the end of either one side in the width direction of the substrate and extended inward of the substrate and the substrate is supported at either one side in the width direction and supported by only one of the enclosing members at least in the section in the direction of the row where the light emitting elements are arranged. Therefore, the cable from the substrate is extended within the width of the substrate. There is no need of increasing the width of the exposure device for cable extension wiring. Even if the substrate is supported at multiple points, the substrate is subject to almost no distortion due to multipoint-support. In addition, the substrate can be smaller in the width direction.

(4) The exposure device according to (1) wherein the side of the substrate on which the cable is connected and the side at which the substrate is supported by the enclosing member are the same side in the width direction of the substrate.

With this structure, the side of the substrate on which the cable is connected and the side at which the substrate is supported by the enclosing member are the same side in the width direction of the substrate. Therefore, the cable and the drive circuit and other circuits that are preferably placed near the cable are provided to the substrate in such a manner on the side supported by the enclosing member. The light emitting elements are provided on the other side where no support is given by the enclosing member and the optical path from the light emitting elements is easily created. In this way, the optical path is not disrupted by the enclosing member. An efficient geometry eliminates wasted spaces and downsizes the exposure device.

(5) The exposure device according to (1) wherein the enclosure has an opening formed by two or more of the enclosing members for serving as the optical path to the outside.

With this structure, two or more enclosing members are used to form an opening for the optical path. This eliminates the secondary processing that is necessary when the opening is formed in one enclosure member. Notched enclosing members are assembled to form an opening. The processing cost is reduced and a low cost exposure device is available. There is no need of providing an area around the opening for the secondary processing. The exposure device itself can be flattened.

(6) The exposure device according to (1) that is an exposure device in which light emitting elements provided to individual pixels constituting an image are used as a light source to emit light according to image information and illuminate an external photosensitive body with the light via a lens, wherein the lens is provided inside the enclosure and the contour of the enclosure in the cross-section orthogonal to the direction of the row is smaller in width at the part where the lens is mounted than at the remaining part.

With this structure, the contour of the enclosure in the cross-section orthogonal to the direction of the row of light emitting elements is smaller in width at the part where the lens is mounted than at the remaining part. In this way, the exposure device is easily positioned in the image forming apparatus in the manner that the lens of the exposure device from which light emerges is placed near the photosensitive body of the image forming apparatus, thereby further downsizing the image forming apparatus.

(7) The exposure device according to (6) wherein the enclosing member of the enclosure is thinner at the part where the lens is mounted than at the remaining part.

With this structure, the enclosing member of the enclosure is thinner at the part where the lens is mounted than at the remaining part. Therefore, the leading end of the exposure device in the exposure direction where the lens is placed and from which the light emerges is thinner. The leading end can easily be placed in a very small space near the photosensitive body where the developing roller and charging roller are placed close together in the image forming apparatus, thereby further downsizing the image forming apparatus.

(8) The exposure device according to (6) wherein one or more of the enclosing members of the enclosure that are used for mounting the lens are at least partly made of a nonmagnetic material.

With this structure, one or more of the enclosing members of the enclosure that are used for mounting the lens are at least partly made of a nonmagnetic material. This prevents the carrier from adhering to the lens and blocking the optical path when the developing agent of the image forming apparatus with which the exposure device is used contains carrier. If the exposure device has any enclosing member made of a magnetic material, the exposure device attracts the carrier and causes the carrier to adhere to the lens. Then, the optical path is blocked by the carrier and the photosensitive body is not illuminated with a necessary amount of light. Using nonmagnetic enclosing members prevents such an event.

(9) The exposure device according to (1) that is an exposure device in which light emitting elements provided to individual pixels constituting an image are used as a light source to emit light according to image information and illuminate an external photosensitive body with the light via a lens, wherein the lens is provided inside the enclosure and the substrate and lens are supported by the same one of the enclosing members.

With this structure, the substrate and lens are supported by the same one of the enclosing members.

Therefore, the entire optical system of the substrate and lens is supported by one stable enclosing member. Then, even if the optical system is supported at multiple points, the optical system is subject to almost no distortion due to multipoint-support.

(10) The exposure device according to (9) wherein the light emitting elements emit light beams orthogonally to the surface of the substrate, the one enclosing member has a surface along the optical axis direction of the lens and a surface orthogonal thereto, the one enclosing member supports the lens with the surface along the optical axis thereof and supports the substrate having light emitting elements with the orthogonal surface.

With this structure, the one enclosing member supporting two optical members, the substrate having light emitting elements and the lens has surfaces orthogonal to each other and supporting these optical members. Therefore, when the lens is mounted after the substrate is mounted on the enclosing member, the enclosing member does not interfere with the lens in the optical axis direction. The focal length of the lens can be adjusted regardless of the accuracy of form of the enclosing member. The lens can be positioned at the operating distance. The corner where these two surfaces meet allows the optical members to be positioned close to each other. The longitudinal surfaces of the optical members are bonded and fixed to the surfaces orthogonal to each other. The optical members easily maintain a high level of accuracy of mounting.

(11) The exposure device according to (1) wherein the one enclosing member supports the substrate at either side in the width direction of the substrate in the ends in the direction of the row.

With this structure, the one enclosing member supports the substrate at either side in the width direction of the substrate in the ends in the direction of the row of light emitting elements. Therefore, the enclosing member makes contact with the substrate throughout the area in the width direction in the ends of the substrate to support the substrate. The wobbling of the substrate is reduced and a high level of accuracy of support is maintained.

(12) The exposure device according to (11) wherein the one enclosing member has on its part one or more projections having a surface in plane with the supported surface of the substrate and the projections support the substrate in the ends in the direction of the row.

With this structure, the one enclosing member has on its part one or more projections having a surface in plane with the supported surface of the substrate and the projections support the substrate in the ends in the direction of the row of light emitting elements.

Therefore, even simply structured projections yield the effect of Embodiment 10 described above. The wobbling of the substrate is reduced and a high level of accuracy of support is maintained.

(13) The exposure device according to (1) wherein the substrate consists of light emitting elements placed on a transparent glass plate and the one enclosing member abuts the opposite surface of the glass plate to the surface where the light emitting elements are placed.

With this structure, the substrate consists of light emitting elements placed on a transparent glass plate and the one enclosing member abuts the opposite surface of the glass plate to the surface where the light emitting elements are placed. Therefore, the substrate abuts and is bonded to the enclosing member at the flat surface of the glass plate where no light emitting elements are provided; the substrate is supported by the enclosing member in a stable and rigid manner.

(14) The exposure device according to (1) wherein the substrate is flanked by two or more of the enclosing members in the width direction and supported by only one of those enclosing members.

With this structure, the substrate is flanked by two or more of the enclosing members in the width direction and supported by only one of those enclosing members. Therefore, the enclosing members except for the one supporting the substrate do not need to have the support-related structure, thereby further easily flattening the exposure device.

(15) The exposure device according to (14) wherein the enclosure has one or more columns provided to any of two or more of the enclosing members for supporting the surface of the other facing enclosing member.

With this structure, the enclosure has one or more columns provided to any of two or more of the enclosing members for supporting the surface of the other facing enclosing member. Therefore, when the exposure device is subject to an external force, the columns prevent the enclosing members from being deformed and then prevent the substrate having light emitting optical elements therein from being damaged.

(16) The exposure device according to (15) wherein the substrate consists of light emitting elements placed on a transparent glass plate and the columns are provided on the same side of the substrate as the surface of the glass plate where the light emitting elements are placed.

With this structure, the substrate consists of light emitting elements placed on a transparent glass plate and the columns are provided on the same side of the substrate as the surface of the glass plate where the light emitting elements are placed. Therefore, the optical path on the opposite side of the glass plate where the light emitting elements are provided is not blocked.

(17) The exposure device according to (14) wherein notches, holes, or other openings of the enclosure that are open to outside the device are sealed with a resin, sheet material, or other plastic material.

With this structure, notches, holes, or other openings of the enclosure that are open to outside the device are sealed with a resin, sheet material, or other plastic material. Therefore, there is no need of provision of additional solid members molded or processed for sealing, thereby reducing components and thus cost.

(18) The exposure device according to (14) wherein the light emitting element substrate and the lens are sealed with a sheet material.

With this structure, the light emitting element substrate and the lens are sealed with a sheet material. Therefore, toner adhesion and contamination to them and between them is prevented.

(19) The exposure device according to (17) or (18) wherein the plastic material or sheet material is black.

With this structure, the plastic material or sheet material is black, which prevents flare light.

(20) An exposure device in which light emitting elements provided to individual pixels constituting an image are used as a light source to emit light according to image information and illuminate an external photosensitive body with the light, comprising an enclosure having two or more enclosing members; a light emitting element substrate placed inside the enclosure and having a row of a plurality of light emitting elements; and one or a plurality of wirings provided outside the light emitting element substrate for constituting electric circuits for light emission of the light emitting elements, wherein the signal line of one or more of the wirings has a smaller electric resistance per unit length than the signal line on the light emitting element substrate for signals electrically connected to the light emitting element substrate.

With this structure, the signal line of one or more of the wirings has a smaller electric resistance per unit length than the signal line on the light emitting element substrate for signals electrically connected to the light emitting element substrate by increasing the cross-sectional area of the signal lines outside the light emitting element substrate. Therefore, with regard to the signal lines, a larger wiring area outside the light emitting element substrate is used and the space necessary for storing the substrate is not increased but rather reduced in height. The electric circuits for light emission of the light emitting elements are constituted by such lines to reduce electric resistance of the signal line and efficiently transmit signals.

(21) An exposure device in which light emitting elements provided to individual pixels constituting an image are used as a light source to emit light according to image information and illuminate an external photosensitive body with the light, comprising an enclosure having two or more enclosing members; a light emitting element substrate placed inside the enclosure and having a row of a plurality of light emitting elements and a drive circuit for electrically driving the light emitting elements for light emission; and one or a plurality of wirings provided outside the light emitting element substrate for constituting electric circuits for light emission of the light emitting elements, wherein at least some of the light emitting elements receive electric driving signals from the drive circuit for light emission via at least one of the wirings.

With this structure, at least some of the light emitting elements receive electric driving signals from the drive circuit for light emission via at least one of the wirings outside the light emitting element substrate. Therefore, the signal line from the drive circuit is provided within the light emitting element substrate for the light emitting elements near the drive circuit and the signal line from the drive circuit is provided outside the light emitting element substrate for the light emitting elements away from the drive circuit. In this way, the light emitting element substrate is not enlarged but rather downsized while the electric resistance of the lines is reduced.

A larger wiring area is available outside the light emitting element substrate. The signal line can be made thicker to reduce the electric resistance per unit length. Such signal lines are used for the light emitting elements away from the drive circuit to near them. In this way, the line resistance from the drive circuit to the light emitting element can be reduced instead of using a relatively long line in a limited wiring area within the light emitting element substrate. The wiring within the light emitting element substrate is reduced and the light emitting element substrate can accordingly be downsized.

(22) The exposure device according to (20) or (21) wherein one or more of the wirings are provided on one or more wiring boards.

With this structure, the wiring is made by a printed wiring board, thereby reducing the number of steps regarding the wiring and reducing the production cost.

(23) The exposure device according to (20) wherein one or more of the wirings are provided on one or more wiring boards and at least one of the wiring boards has a drive circuit for electrically driving the light emitting elements of the light emitting element substrate for light emission.

With this structure, the wiring is made by a printed wiring board, and a drive circuit for the light emitting element substrate is provided on the printing board, minimizing the circuit wiring on the light emitting element board and downsizing the substrate.

(24) The exposure device according to (22) that is an exposure device in which light emitting elements provided to individual pixels constituting an image are used as a light source to emit light according to image information and illuminate an external photosensitive body with the light via a lens, comprising a lens for directing light emitted from the light emitting elements to the outside, wherein the enclosure has an opening formed by two or more of the enclosing members for serving as the optical path to the outside and the light emitting element substrate is supported behind the lens and one or more of the circuit boards are supported behind the light emitting element substrate in the direction and orientation of the illumination.

With this structure, the enclosure has an opening formed by two or more of the enclosing members for serving as the optical path to the outside and the light emitting element substrate is supported behind the lens and one or more of the circuit boards are supported behind the light emitting element substrate in the direction and orientation of the illumination, thereby further flattening the exposure device with low cost.

In other words, two or more substrates are stored in the enclosure. Among them, the light emitting element substrate is supported behind the lens and one or a plurality of other circuit boards are supported behind the light emitting element substrate. In this way, the space necessary for storing the substrates are reduced in height. Furthermore, two or more enclosing members are used to form an opening for the optical path. This eliminates the secondary processing that is necessary when the opening is formed in one enclosure member. Notched enclosing members are assembled to form an opening. There is no need of providing an area around the opening for the secondary processing and the enclosure itself can accordingly be flattened, thereby flattening the entire enclosure. In addition, the enclosure requires no secondary processing cost, realizing a low cost enclosure.

(25) The exposure device according to (24) wherein the light emitting element substrate and one or more of the circuit boards are provided in the manner that when seen from the illumination side of the device, the dimension of the circuit boards in the width direction thereof is not larger than the dimension of the light emitting element board in the width direction thereof in their projected contours.

With this structure, the light emitting element substrate and one or more of the circuit boards are provided in the manner that when seen from the illumination side of the device, the dimension of the circuit boards in the width direction thereof is not larger than the dimension of the light emitting element board in the width direction thereof in their projected contours. Therefore, the space necessary for storing the boards can be reduced to the size of the light emitting element substrate that is essential to the device. The enclosure can be flattened nearly to the minimum.

(26) The exposure device according to (24) that is an exposure device in which signal connection for transmitting image information to and from an external device is made, light emitting elements provided to individual pixels constituting an image are used as a light source to emit light according to image information and illuminate an external photosensitive body with the light, comprising an external connection means having a terminal for connecting a signal line transmitting signals to and from an external device, wherein a terminal of the external connection means is provided outside and away from the enclosure and connected to a signal line from the external device.

With this structure, an external connection terminal, connector, or a relay board and other external connection terminal having them, which are an external connection means for the connection of an inter-device cable between the exposure device and the external device is provided outside and away from the enclosure, by which the wire, connector, and other terminal regarding the external connection is eliminated from the enclosure to minimize the size of the enclosure. The inter-device cable to the external drive means that is an external device for controlling the illumination of the exposure device and an external connection terminal connected thereto are provided in a relatively large space available within the image forming apparatus in which the exposure device is installed. The positioning of the exposure device within the image forming apparatus is facilitated. In addition, the total device cost can be reduced by using inexpensive inter-device cable material, connector and other line materials relatively irrelevantly to their dimension and form.

(27) An image forming apparatus forming images according to image information, comprising the exposure device according to any of (1) to (3) or (20) or (21).

With this structure, the image forming apparatus is further downsized by using the downsized and flattened exposure device.

### INDUSTRIAL APPLICABILITY

As described above, the exposure device of the present invention is downsized and flattened and improves the degree of freedom of system design of the image forming apparatus. Then, the exposure device of the present invention can downsize the image forming apparatus and be applied, for example, to printers, copiers, facsimile machines in the business or SOHO market and small on-demand printers in the small lot printing market.

1. An exposure device in which light emitting elements provided to individual pixels constituting an image are used as a light source to emit light according to image information and illuminate an external photosensitive body with the light, comprising:
an enclosure having one or a plurality of enclosing members; and
a substrate placed inside the enclosure and having a row of a plurality of light emitting elements,
wherein the substrate is supported only at either one side in the width direction of the substrate surface that is orthogonal to the direction of said row and supported by only one of said enclosing members at least in the section in the direction of said row where said light emitting elements are arranged.

2. The exposure device according to claim 1, wherein said light emitting elements are localized in the other side of said substrate in the width direction.

3. The exposure device according to claim 1, wherein said substrate has a connection part for connecting a cable near the end on either one side of said substrate in the width direction, and
said cable is extended inward of said substrate.

4. The exposure device according to claim 3, wherein the side on which said cable is connected and the side at which said substrate is supported by said enclosing member are the same side in the width direction of said substrate.

5. The exposure device according to claim 1, wherein said enclosure has an opening formed by two or more of said enclosing members for serving as the optical path to the outside.

6. The exposure device according to claim 1, further comprising a lens on the optical path from said light source to said photosensitive body,
wherein the contour of said enclosure in the width direction of said substrate is smaller at the part where said lens is mounted than at the part where said substrate is stored.

7. The exposure device according to claim 6, wherein said enclosing member is thinner at the part where said lens is mounted than at the part where said substrate is mounted.

8. The exposure device according to claim 6, wherein said enclosing member used for mounting said lens is at least partly nonmagnetic.

9. The exposure device according to claim 1, further comprising a lens on the optical path from said light source to said photosensitive body,
wherein said lens is supported by the same one of said enclosing members as the one supporting said substrate.

10. The exposure device according to claim 9, wherein said light emitting elements emit light beams orthogonally to the surface of said substrate, and
said one enclosing member has a surface for mounting said lens that is along the optical axis of said lens and a surface orthogonal to the surface for mounting said lens and said substrate having light emitting elements is supported by said orthogonal surface.

11. The exposure device according to claim 1, wherein said one enclosing member supports said substrate also at the other side in the width direction of said substrate in the ends in the direction of said row.

12. The exposure device according to claim 11, wherein said one enclosing member has on its part one or more projections having a surface in plane with the supported surface of said substrate and said projections support said substrate at the ends in the direction of said row.

13. The exposure device according to claim 1, wherein said light emitting elements are placed on a transparent glass substrate, and
said one enclosing member abuts the opposite surface of said glass plate to the surface where said light emitting elements are placed.

14. The exposure device according to claim 1, wherein said substrate is flanked by two or more of said enclosing members in said width direction and supported by only one of those enclosing members.

15. The exposure device according to claim 14, wherein said enclosure has one or more columns provided to any of two or more of said enclosing members for supporting the surface of the other facing enclosing member.

16. The exposure device according to claim 15, wherein said light emitting elements are placed on a transparent glass plate, and
said columns are provided on the same side of said substrate as the surface of said glass plate where said light emitting elements are placed.

17. The exposure device according to claim 14, wherein notches, holes, or other openings of said enclosure that are open to outside the device are sealed with a resin, sheet material, or other plastic material.

18. The exposure device according to claim 17, wherein said plastic material is black.

19. The exposure device according to claim 14, further comprising:
a lens provided on the optical path from said light source to said photosensitive body; and
a sheet material for sealing said substrate and said lens.

20. The exposure device according to claim 19, wherein said sheet material is black.

21. The exposure device according to claim 1, further comprising one or a plurality of wirings outside said substrate for constituting electric circuits for light emission of the light emitting elements on said substrate; and
the signal line of one or more of said wirings has a smaller electric resistance per unit length than the signal line on said substrate for signals electrically connected to said substrate.

22. The exposure device according to claim 21, wherein said substrate has a drive circuit for electrically driving the light emitting elements for light emission, and
at least some of the plurality of light emitting elements receive electric driving signals from said drive circuit for light emission via at least one of said wirings.

23. The exposure device according to claim 21, wherein one or more of said wirings are provided on one or more wiring boards.

24. The exposure device according to claim 23, wherein at least one of said wiring boards has a drive circuit for electrically driving the light emitting element of said wiring board for light emission.

25. The exposure device according to claim 23, wherein at least one of said wiring boards is provided outside said enclosure.

26. The exposure device according to claim 23, further comprising a lens on the optical path from said light source to said photosensitive body,
wherein said lens, substrate, and wiring boards are provided in said enclosure in this order from said photosensitive body side.

27. The exposure device according to claim 26, wherein the dimension of said wiring boards in the width direction of said substrate surface is not larger than the dimension of said substrate in the width direction thereof.

28. The exposure device according to claim 21, further comprising an external connection means provided outside said enclosure for connecting the signal line to an external device and the signal line from said enclosure.

29. An image forming apparatus comprising the exposure device according to claim 1.

30. An exposure device in which light emitting elements provided to individual pixels constituting an image are used as a light source to emit light according to image information and illuminate an external photosensitive body with the light, comprising:
an enclosure having a plurality of enclosing members;
a light emitting element substrate placed inside said enclosure and having a row of a plurality of light emitting elements; and
one or a plurality of wirings provided outside said light emitting element substrate for constituting electric circuits for light emission of said light emitting elements,
wherein the signal line on one or more of said wirings has a smaller electric resistance per unit length than the signal line on said substrate for signals electrically connected to said light emitting element substrate.

31. An exposure device in which light emitting elements provided to individual pixels constituting an image are used as a light source to emit light according to image information and illuminate an external photosensitive body with the light, comprising:
an enclosure having a plurality of enclosing members;
a light emitting element substrate placed inside said enclosure and having a row of a plurality of light emitting elements; and
one or a plurality of wirings provided outside said light emitting element substrate for constituting electric circuits for light emission of said light emitting elements,
wherein said substrate has a drive circuit for driving said light emitting elements for light emission, and
at least some of the plurality of light emitting elements receive electric driving signals from said drive circuit for light emission via at least one of said wirings.
